(19) United States
(12) Patent Application Publication
(10) Pub. No.: US 2009/0293505 A1
(43) Pub. Date: Dec. 3, 2009

(54) LOW VIBRATION LIQUID HELIUM CRYOSTAT

(75) Inventor: Chao Wang, Manlius, NY (US)

Correspondence Address: BROWN & MICHAELS, PC;400 M & T BANK BUILDING, 118 NORTH TIOGA ST, ITHACA, NY, 14850, US

(73) Assignee: CRYOMECH, INC., Syracuse, NY (US)

(21) Appl. No.: 12/473,503

(22) Filed: May 28, 2009

Related U.S. Application Data
(60) Provisional application No. 61/057,025, filed on May 29, 2008.

(51) Int. Cl. F17C 3/00; F25J 1/00; F25B 9/00

(52) U.S. Cl. 62/51.1; 62/608

(57) ABSTRACT

An extra-low vibration cryostat, which incorporates a cryocooler and cryostat to cool and house a vibration-sensitive device, with the cryocooler and cryostat sealed gas-tight to each other, but mechanically isolated, so that vibration from the cryocooler does not affect the device.

### REFERENCE TO RELATED APPLICATIONS

This application claims one or more inventions which were disclosed in Provisional Application No. 61/057,025, filed May 29, 2008, entitled “LOW VIBRATION LIQUID HELIUM CRYOSTAT”. The benefit under 35 USC §119(e) of the U.S. provisional application is hereby claimed, and the aforementioned application is hereby incorporated herein by reference.

### BACKGROUND OF THE INVENTION

1. Field of the Invention

The invention pertains to the field of apparatus used to maintain constant low temperature. More particularly, the invention pertains to refrigeration and storage apparatus for liquefied gasses.

2. Description of Related Art

Many applications, especially those involving low temperature superconductors, require a supply of extremely cold liquid, such as liquid Helium, to operate. Some devices for these applications, especially those involving highly sensitive sensors, are extremely sensitive to vibration. An example of a vibration-sensitive low-temperature device is a Superconducting Quantum Interference Devices (SQUID), which can detect tiny magnetic signals and need to be cooled to ˜4.2K.

Cryocoolers capable of producing liquid Helium at such low temperatures most often use mechanical displacers (a Gifford-McMahon, or “GM cryocooler”) or pulse tubes (“pulse tube cryocooler”) to generate cooling, often in multiple stages. These reciprocating mechanical displacers or the pulsating gas in the pulse tubes create mechanical vibrations which can disrupt the operation of the sensitive superconducting devices.

Prior art cryocoolers for cooling sensitive low temperature devices relied upon physical contact between the lowest temperature cooling stations of the cryocoolers and the device. While this is efficient from a heat transfer point of view, it permits transfer of vibrations from the operation of the cryocooler to the device, which is undesirable.

### SUMMARY OF THE INVENTION

The invention is an extra-low vibration cryostat, which incorporates a cryocooler and cryostat to cool and house a vibration-sensitive device, with the cryocooler and cryostat sealed gas-tight to each other, but mechanically isolated, so that vibration from the cryocooler does not affect the device.

### BRIEF DESCRIPTION OF THE DRAWING

FIG. 1 shows a schematic view of the cryostat of the invention with a two-stage pulse-tube cryocooler with external pulsator.

FIG. 2 shows the cryostat with a two-stage pulse-tube cryocooler with integrated pulsator.

FIG. 3 shows a cryostat with a vibration damping part on the bottom.

FIG. 4 shows the cryostat with a two-stage GM cryocooler.

FIG. 5 shows the cryostat with a single-stage cryocooler.

### DETAILED DESCRIPTION OF THE INVENTION

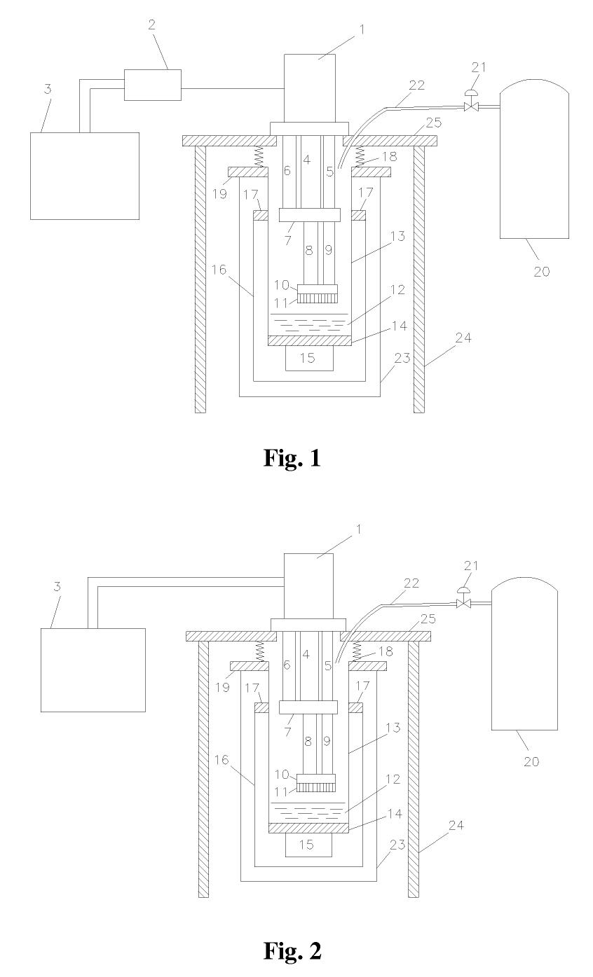

FIG. 1 shows the cryostat of the invention.

The cryostat (23) has a gas-tight chamber or neck (13) for containing the low-temperature liquid helium (He) or other cryogen (12). A heat exchange plate (14) is cooled by the cryogen (12), and in turn cools the device (15) attached to the bottom of the cryostat neck (13). The lower part of neck (13) is surrounded by a radiation shield (16) which limits absorption of heat from the surroundings to the cryogen (12) in the neck (13). The top of the cryostat is capped with a room-temperature flange (19) which is mounted via flexible bellows (18) to a mount (25), mounted upon a stand (24). The flexible bellows (18) mechanically isolates the support (25) from the cryostat (23), so that mechanical vibrations at the support (25) are not transmitted to the cryostat (23), while forming a gas-tight enclosure with the gas-tight neck or chamber (13) of the cryostat (23).

The invention incorporates a cryocooler, which is used to produce the low-temperature liquid Helium (He) or other cryogen for cooling the device (15), The cryocooler is shown as a two-stage pulse-tube type cryocooler. In the pulse-tube cryocooler shown in FIG. 1, the cold end is made up of two stages: the first stage has a pulse tube (6), regenerator (4), and cooling station (7); the second stage has a pulse tube having a warm end (5) and cold end (9) divided by the first stage cooling station (7), a regenerator (8), and a cooling station (10) equipped with a condenser (11). Compressed helium gas is supplied to the cryocooler warm end (1) from a compressor (3), and a pulsator such as a rotating valve (2) causes the gas to pulsate to and from the cold head of the cooler. This causes the second stage cooling station (10) to be cooled down to ˜4.2K.

The warm end (1) of the cryocooler is mounted on the support (25), and the cold end of the cryocooler extends into the neck (13) of the cryostat.

Cryogen gas from a storage tank (20) is fed through a pressure regulator (21) and hose (22) into the neck (13) of the cryostat (23). The gas is cooled as it passes the first stage tubes (4), (5), (6) and the first stage cooling station (7) and second stage tubes (8) and (9), and condenses into liquid on the condenser (11). The liquid cryogen drips from the condenser (11), and collects in a pool of liquid (12) in the cryostat. Additionally, any cryogen which boils off from the pool (12) due to heat from the device (15) rises up, and is recondensed by contact with the condenser (11), minimizing loss of cryogen or maintain low or zero boil-off.

In order to further minimize heat transfer to the liquid cryogen, the radiation shield (16) is cooled by a cooling station (17). There is a narrow gap between the cooling station (17) and the first stage cooling station (7). The cooling capacity is transferred from the cooling station (7) to the cooling station (17) by convection heat transfer of gas.

The design of the invention minimizes transmission of vibrations to the device (15). There is no direct mechanical contact between the device (15) and the cryocooler's second stage cold station (10) which could transmit vibration. The pulsator (2) (also called a rotary valve) is remotely mounted, with a flexible line connection connecting it to the cryocooler head (1). The cold end of the cryocooler is suspended in the neck (13) of the cryostat (23) without contact between the cold end of the cryocooler and the neck (13) within which it is located. Finally, the cryostat (23) is suspended from its support (25) by the flexible bellows (18), producing a high degree of mechanical isolation between the support (25) and the cryostat (23).

Thus, any vibrations generated by the operation of the cryocooler are almost entirely isolated from the device (15).

FIG. 2 shows the cryostat of the invention using a cryocooler of integrated design, in which the pulsator (2) of FIG. 1 is integrated into the cooler head (1). This integrated pulsator arrangement is shown in the present inventor's U.S. Pat. No. 6,378,312.

FIG. 3 shows the cryostat of the invention, as in FIG. 2, with the addition of a vibration damping part (28) on the bottom. The vibration damping part could be a rubber pad, a spring support, etc., to isolate the vibration from ground.

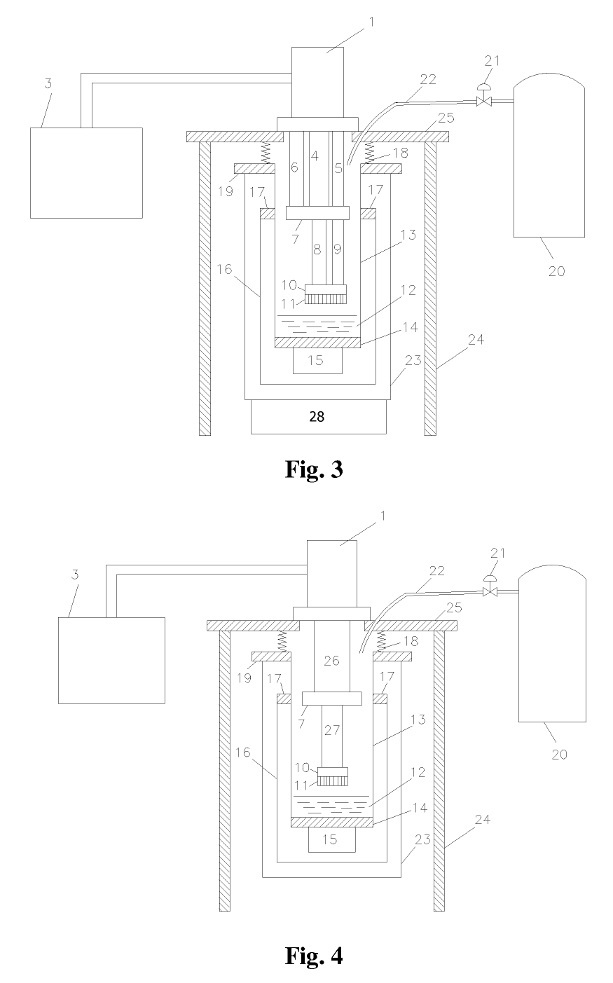

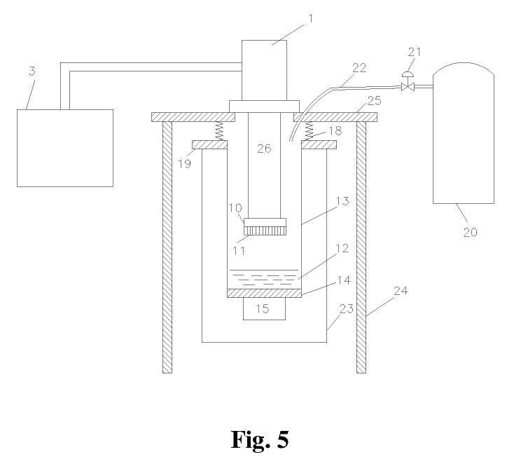

FIG. 4 shows the cryostat of the invention, as used with a two-stage Gifford-McMahon (GM) cryocooler, in which (26) is the 1st stage tube and (27) is the 2nd stage tube. A Gifford-McMahon cooler is similar to the pulse-tube type cooler shown in FIGS. 1-3, but has mechanical displacers instead of pulse-tubes.

FIG. 5 shows the cryostat with a single-stage cryocooler, using only a first stage (26). The liquid cryogen (12) can be Hydrogen (H₂), Neon (Ne), Nitrogen (N₂), Oxygen (O₂), Argon (Ar), etc.

It will be understood by one skilled in the art that while the various figures have shown the cryostat of the invention with single- and two-stage cryocoolers of the pulse-tube and Gifford-McMahon types, that the invention is not limited to any particular type of cooler. Three-stage coolers could be used, or cryocoolers of other kinds, within the teachings of the invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

Table of Reference Numbers

| | |
|---|---|
| 1 | Cryocooler head |
| 2 | Pulsator (Rotating valve) |
| 3 | Compressor |
| 4 | First stage regenerator |
| 5 | Second stage pulse tube - warm end |
| 6 | First stage pulse tube |
| 7 | First stage cooling station |
| 8 | Second stage regenerator |
| 9 | Second stage pulse tube - cold end |
| 10 | Second stage cooling station |
| 11 | Condenser |
| 12 | Liquid Cryogen |
| 13 | Neck of the cryostat |
| 14 | Heat exchange plate |
| 15 | Device to be cooled |
| 16 | Radiation shield |
| 17 | Cooling station for radiation shield |
| 18 | flexible bellows seal for vibration |
| | isolation from the cryocooler |
| 19 | Room temperature flange of the |
| | cryostat |
| 20 | Tank of Helium gas |
| 21 | Pressure regulator |
| 22 | Hose for gas |
| 23 | Cryostat |
| 24 | Stand |
| 25 | Cryocooler mount |
| 26 | First stage of GM cryocooler |
| 27 | Second stage of GM cryocooler |
| 28 | Vibration damper |

What is claimed is:

1. A low-vibration cryostat comprising:
a) a mount for a cryocooler;
b) a cryostat adjacent to the mount for the cryocooler, comprising:
i) a gas-tight chamber having a bottom and an open top;
ii) a heat-exchange plate in the bottom of the gas-tight chamber;
iii) a gas inlet for admitting a cryogen into the gas-tight chamber;
c) a gas-tight flexible bellows having an upper end sealed to the mount for the cryocooler and a lower end sealed to the open top of the cryostat;
such that when a cryocooler is mounted on and sealed to the mount, with a cold end extending through the open top into the gas-tight chamber of the cryostat, a gas-tight enclosure is formed in which the cryocooler is mechanically isolated from the cryostat and gas from the gas inlet is cooled into liquid by the cryocooler, filling the bottom of the gas-tight chamber over the heat-exchange plate.

2. The cryostat of claim 1, further comprising a radiation shield inside the cryostat and outside the gas-tight chamber.

3. The cryostat of claim 1, further comprising a source of cryogen gas.

4. The cryostat of claim 1, in which the source of cryogen gas is a supply of helium.

5. The cryostat of claim 1, further comprising a low-temperature device, in contact with the heat-exchange plate, such that the device is cooled by the liquid cryogen in contact with the heat-exchange plate while being mechanically isolated from the cryocooler.

6. The cryostat of claim 5, in which the device is a SQUID or cryogenic oscillator.

7. The cryostat of claim 1, further comprising a vibration damper underneath and supporting the cryostat.

8. The cryostat of claim 1, further comprising a stand supporting the mount for the cryocooler.

9. A low-vibration cryocooler system for a low-temperature device, comprising:
a) a cryocooler mounted upon and sealed to a cryocooler mount, having a cold end extending downward from the mount;
b) a cryostat adjacent to the mount for the cryocooler, comprising:
i) a gas-tight chamber having a bottom and an open top, the cold end of the cryocooler extending into the gas-tight chamber;
ii) a heat-exchange plate in the bottom of the gas-tight chamber;
iii) a gas inlet for admitting a cryogen into the gas-tight chamber;
c) a gas-tight flexible bellows having an upper end sealed to the mount for the cryocooler and a lower end sealed to the open top of the cryostat, forming a gas-tight enclosure enclosing the cold end of the cryocooler and the gas-tight chamber of the cryostat;
such that the cryocooler is mechanically isolated from the cryostat, and gas from the gas inlet is cooled into liquid by the cryocooler, filling the bottom of the gas-tight chamber over the heat-exchange plate.

10. The cryocooler system of claim 9, further comprising a radiation shield inside the cryostat and outside the gas-tight chamber.

11. The cryocooler system of claim 9, further comprising a source of cryogen gas.

12. The cryocooler system of claim 9, in which the source of cryogen gas is a supply of helium.

13. The cryocooler system of claim 9, further comprising a low-temperature device, in contact with the heat-exchange plate, such that the device is cooled by the liquid cryogen in contact with the heat-exchange plate while being mechanically isolated from the cryocooler.

14. The cryocooler system of claim 13, in which the device is a SQUID or cryogenic oscillator.

15. The cryocooler system of claim 9, further comprising a vibration damper underneath and supporting the cryostat.

16. The cryocooler system of claim 9, further comprising a stand supporting the mount for the cryocooler.

17. The cryocooler system of claim 9, in which the cryocooler is a Gifford-McMahon cooler.

18. The cryocooler system of claim 9, in which the cryocooler is a pulse-tube cooler.

19. The cryocooler system of claim 9, in which the cryocooler is a two-stage cooler and at least the second stage of the cryocooler extends into the gas-tight chamber of the cryostat.

20. The cryocooler system of claim 9, in which the cryocooler is a single-stage cryocooler.
